(19) United States
(12) Patent Application Publication
(10) Pub. No.: US 2020/0319016 A1
(43) Pub. Date: Oct. 8, 2020

(54) BASE FOR WEIGHING PLATFORM ASSEMBLY

(71) Applicant: Robert Bosch Limitada, Campinas SP (BR)

(72) Inventors: Alvaro Augusto Vasconcelos, Campinas - SP (BR); Luis Ricardo Lopes Brombim, Paulinia SP (BR)

(21) Appl. No.: 16/767,055

(22) PCT Filed: Nov. 27, 2018
(86) PCT No.: PCT/BR2018/050439

§ 371 Date: May 26, 2020

(30) Foreign Application Priority Data
Nov. 27, 2017 (BR) BR102017025345-7

(51) Int. Cl. G01G 21/23; G01G 21/28

(52) U.S. Cl. CPC G01G 21/23; G01G 17/08; G01G 21/28

(57) ABSTRACT

This invention relates to a platform for the assembly of a weighing platform formed by a first structure (2), a second structure (3) and a third structure (4), each of the first and second structures (2,3) being associated with a longitudinal end of the third structure (4) to form the base (1), the first, second and third structures (2, 3, 4) being pre-molded.

### BACKGROUND

This invention relates to a base for weighing platform assemblies, particularly weighing platforms used in the agricultural and livestock sector.

Weighing platforms are devices that optimize the weighing of animals. Weighing platforms usually accommodate weighing bars that are positioned under their structures and are applied in several areas, including in the agricultural sector, where there is a need to weigh animals frequently, accurately and in large quantities, which requires the use of robust, precise and durable equipment.

Usually, a concrete foundation is used as a base to attach the weighing bars provided under the platforms. This foundation attempts to hold the weighing bars in place, as well as ensuring the leveling of the entire set of bars and the platform.

The work in producing this foundation is usually time-consuming, since it depends on an initial preparation of the soil for later assembly of a concrete mold, which requires some curing time for the material.

As a rule, this foundation is prepared by the owner of the farm who, in addition to making the preparation, must leave the fixtures of the weighing bars open, i.e. leaving the holes necessary to place the staples to be concreted. Thus, when receiving and installing the weighing bar, one should wait for a while for the concrete to be cured in order to fixate the staples.

There is also a difficulty in aligning and leveling the fixing bases of the weighing bars, since the foundation has a rather irregular surface.

### SUMMARY

In order to expedite the production process of the bases for the weighing platforms, as well as to assure a high degree of precision in the installation of the weighing bars, this invention provides a base for pre-molded weighing platform assembly, which is commercialized in its final format, ready for foundation.

The base for weighing platform assembly of this invention comprises a specific shape that contributes to order the passage of the animals on the weighing platform, in addition to comprising a pre-shaped structural portion to support the weighing platform, ensuring the correct leveling and positioning of the weighing bars in relation to the platform.

The goal of this invention is achieved by a weighing platform assembly base formed by a first structure, a second structure and a third structure, each of the first and second structures being associated with a longitudinal end of the third structure to form the base, with the first, second and third structures being pre-molded.

### BRIEF DESCRIPTION OF THE DRAWINGS

This invention shall be further described based on an execution example represented in the drawings. The figures show:

FIG. 1—a first schematic perspective view of the weighing platform assembly base of this invention;

FIG. 2—a second schematic perspective view of the weighing platform assembly base of this invention;

FIG. 3—a schematic perspective view of the first and second structures forming the weighing platform assembly base of this invention;

FIG. 4—a schematic perspective view of the third structure composing the weighing platform assembly base of this invention;

FIG. 5—a top schematic view of the weighing platform assembly base of this invention;

FIG. 6—a side schematic view of the weighing platform assembly base of this invention;

FIG. 7—a schematic perspective view of a first alternative constructive configuration of the weighing platform assembly base of this invention; and

FIG. 8—a schematic perspective view of a second alternative constructive configuration of the weighing platform assembly base of this invention.

### DETAILED DESCRIPTION

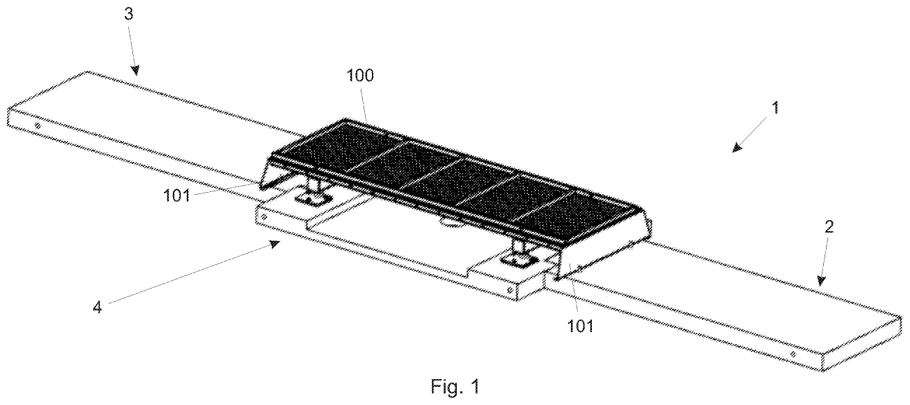

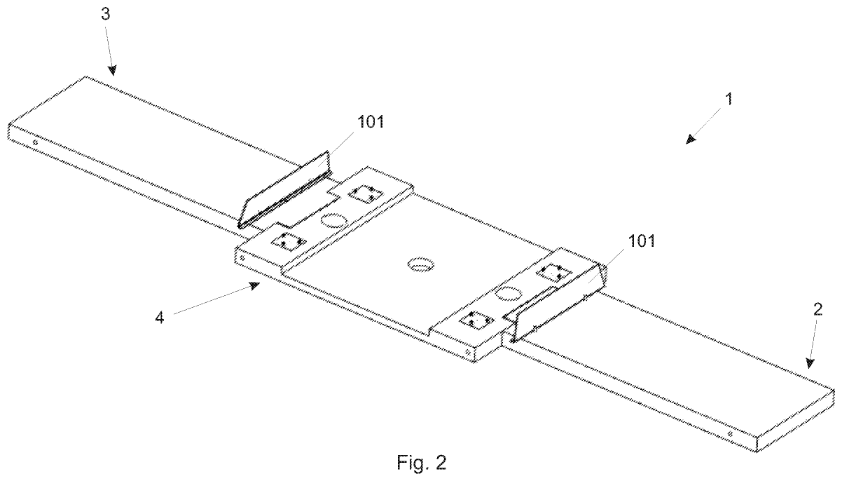

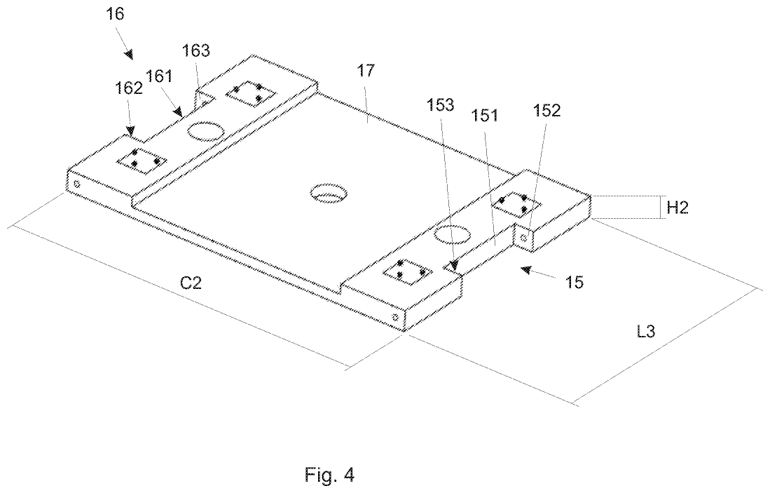

FIGS. 1 to 6 illustrate an embodiment of the base 1 for the weighing platform assembly 100 according to this invention.

Referring to FIG. 1, the base 1 is formed by a first structure 2, a second structure 3 and a third structure 4, with the first, second and third structures 2, 3, 4 having a substantially rectangular cross-section when designed in a top view. The weighing platform 100 is installed on the third structure 4, the assembly being provided with bulkheads 101 installed at a longitudinal end of the first and second structures 2,3 and supported on the longitudinal ends of the weighing platform 100, the bulkheads 101 being capable of blocking the dirt from the animals' feet during weighing, avoiding the accumulation of waste/debris under the platform 100.

The first, second and third structures 2, 3, 4 are pre-molded, requiring the use of a mold or shape for their manufacturing. The molds or shapes are made from wood, or steel, or aluminum, or a polymeric material, or another material suitable for such application.

The first, second and third structures 2, 3, 4 are preferably manufactured from concrete, and other materials may be used, provided that the material is capable of withstanding the high applied loads.

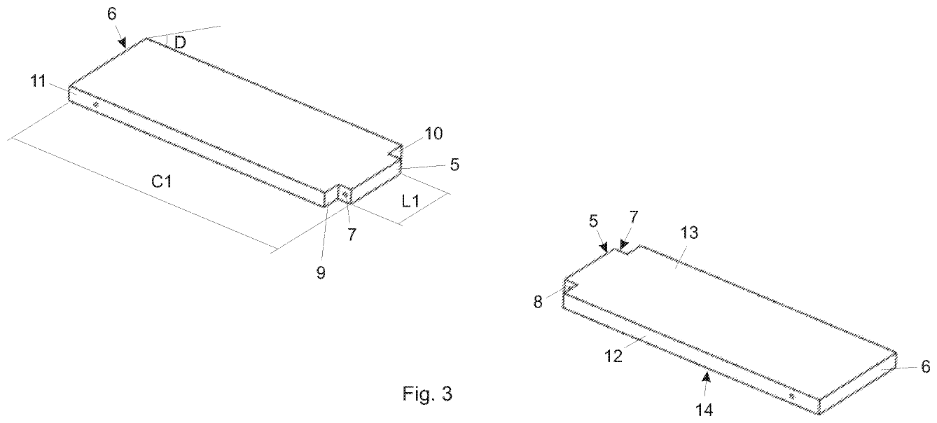

As shown in FIGS. 3 to 6, the first and second structures 2,3 are of an identical shape, each of the first and second structures 2,3 being engaged with a longitudinal end of the third structure 4,

Each of the first and second structures 2,3 consists of a first end surface 5 and a second end surface 6, both flat and substantially rectangular in shape, the first end surface 6 being longitudinally opposite to the first end surface 5, so that the distance between the first and second end surfaces 5, 6 defines a first length C1 of each of the first and second structures 2,3. The first length C1 varies between 1500 and 2500 millimeters, being preferably equal to 2000 millimeters.

From the first end surface 5, a first side surface 7 and a second side surface 8 project themselves, both flat and substantially rectangular in shape, being arranged perpendicular to the first end surface 5, with the first and second side surfaces 7, 8 being transversely opposite and spaced apart by a distance defining a first width L1 of the first end surface 5. The first width L1 varies between 1300 and 1400 millimeters, being preferably equal to 1350 millimeters.

The first and second side surfaces 7, 8 extend longitudinally toward the second end surface 6 to a first distance D1, defining the width of the first and second side surfaces 7, 8. The first distance D1 is less than or equal to 100 millimeters.

From the first and second side surfaces 7, 8 a third side surface 9 and a fourth side surface 10 project themselves, both flat and substantially rectangular in shape, being arranged respectively perpendicular to the first and second side surfaces 7, 8, with the third and fourth side surfaces 9, 10 being longitudinally opposed to the first end surface 5.

The third and fourth side surfaces 9, 10 project from the first distance D1 and extend transversely, in the direction opposite to the longitudinal axis of each of the first and second structures 2,3, to a second distance D2, which defines the width of the third and fourth side surfaces 9, 10. The second distance D2 is less than or equal to 100 millimeters.

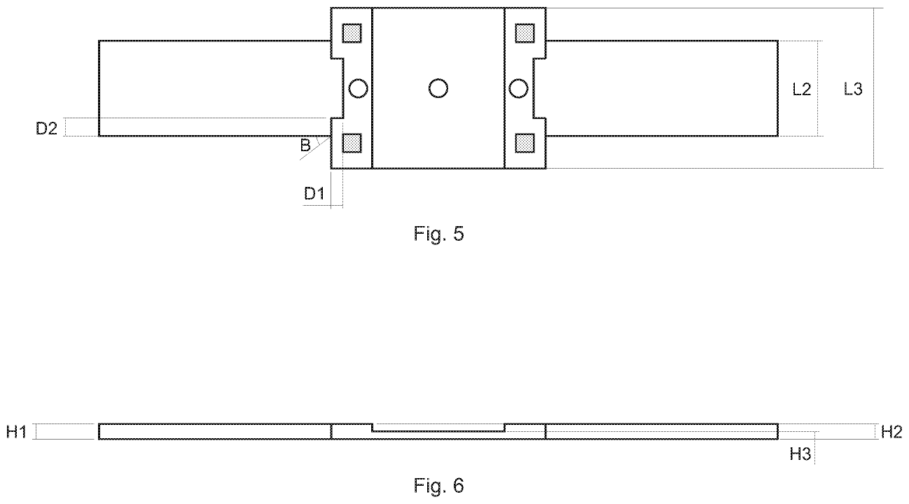

From the third and fourth side surfaces 9, 10 project themselves, respectively, a fifth side surface 11 and a sixth side surface 12 project from the third and fourth side surfaces 9,10, both of which are flat and substantially rectangular in shape, and placed, preferably, but not necessarily, perpendicularly from the third and fourth side surfaces 9, 10, when the first angle B equals zero, as shown in FIG. 5.

In an alternative preferred configuration, the fifth and sixth side surfaces 11, 12 are placed inclined to the third and fourth side surfaces 9, 10, when the first angle B is greater than zero. The first angle B admits a value from zero to 90 degrees, so that when the first angle B is greater than zero, the first and second structures 2,3 comprise a “swallowtail” cross section.

The fifth and sixth side surfaces 11, 12 are transversely opposite and spaced apart by a distance defining a second width L2 of the second end surface 6. The second width L2 varies between 1500 and 1600 millimeters, being preferably equal to 1550 millimeters.

The fifth and sixth side surfaces 11, 12 extend longitudinally from the first distance D1 until they reach the second end surface 6.

The first and second structures 2,3 are further formed by a first face 13 and a second face 14, which protrude from the first end surface 5 and extend longitudinally until they reach the second end surface 6, with the first and second faces 13, 14 being flat and preferably, but not necessarily, perpendicular to the first and second end surfaces 5, 6, when the second angle D is equal to zero, as shown in FIG. 3.

In an alternative preferred configuration, the first face 13 is inclined in relation to the second end surface 6, when the second angle D is greater than zero. The second angle D admits a value from zero to 90 degrees, so that when the second angle D is greater than zero, the first and second structures 2,3 comprise a ramp portion defined in the first face 13.

The first face 13 is transversely opposite to the second face 14, being spaced apart by a distance defining a first height H1 of the first and second structures 2,3. The first height H1 is less than or equal to 150 millimeters.

In turn, the third structure 4 has a substantially rectangular shape with a second length C2 ranging from 1500 to 2500 millimeters, preferably equal to 2000 millimeters, a third width L3 varying between 1700 and 1800 millimeters, being preferably equal to 1750 millimeters and a second height H2 equal to or greater than 150 millimeters, preferably equal to the first height H1.

The third structure 4 comprises, at its longitudinal ends, a first groove 15 and a second groove 16, of a substantially rectangular shape, provided in a central portion of the longitudinal ends of the third structure 4. The first and second grooves 15, 16 are designed to engage the first and second structures 2,3 with the third structure 4.

The first end surface 5 of each of the first and second structures 2,3 touches a bottom surface 151, 161 of the first and second grooves 15, 16, while the first and second side surfaces 7, 8 of each of the first and second structures 2, 3 maintain contact with side walls 152, 153, 162, 163 of the first and second grooves 15, 16.

Further, the third structure 4 comprises a channel 17 which extends transversely along the entire third width L3 of the third structure 4, defining a recess surface in a central portion of the third structure 4 with a third height H3 smaller than the second height H2. The third height H3 is less than or equal to 120 millimeters.

This recess portion defined by the channel 17 is provided under the weighing platform 100 to enable the passage of water and prevent debris brought by rainwater or even by the passage of the animals from accumulating on the sides of the platform 100, influencing the correct operation of the platform 100.

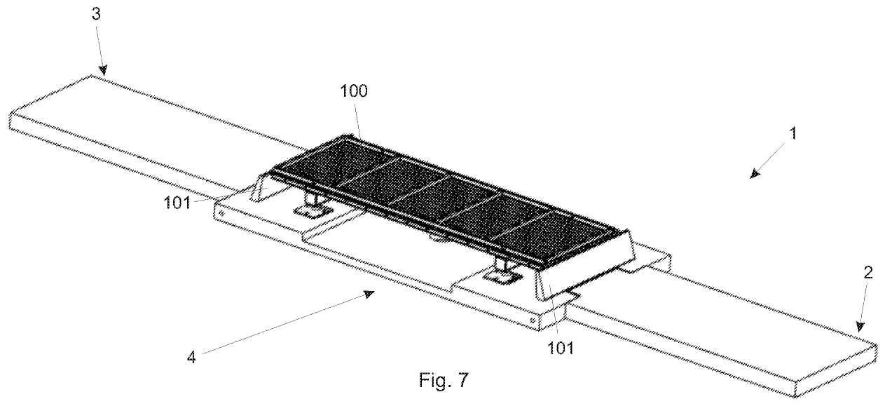

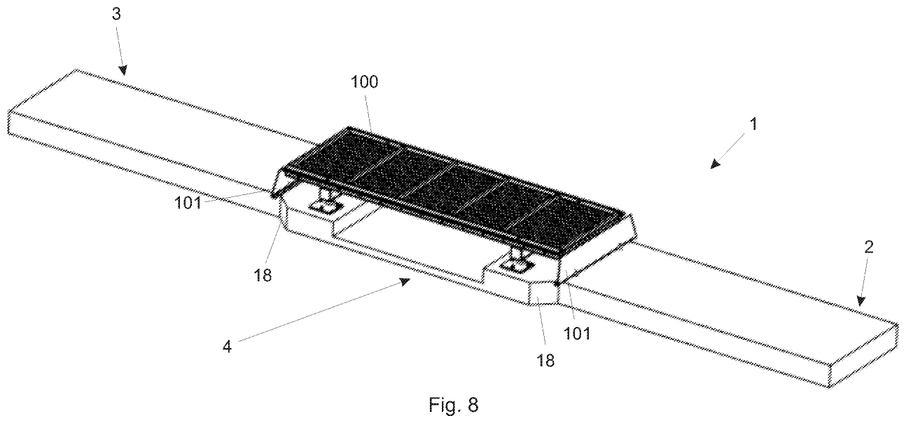

FIGS. 7 and 8 illustrate alternative constructive configurations of the base 1 of this invention.

In the first alternative constructive configuration, shown in FIG. 7, the bulkheads 101 are installed at the longitudinal ends of the third structure 4, being secured on the third structure 4 and not on the first and second structures 2,3 as shown in FIG. 1. In this alternative constructive configuration, one may notice that in case of breakage or damage of the first and/or second structures 2, 3, the exchange of the first and/or second structures 2,3 may be done without the need to uninstall the bulkheads 101.

A second alternative constructive configuration is illustrated in FIG. 8, wherein the bulkheads 101 are installed on a longitudinal end of the first and second structures 2,3 as shown in FIG. 1. One may notice, however, that in the second alternative constructive configuration, the third structure 4 has beveled edges 18. The execution of chamfers at the edges enables the elimination of sharp corners which may eventually injure the animal, as well as being able to prevent the premature breaking of the corner portions of the third structure 4.

The first and second structures 2,3 are fixed to the third structure 4 by means of steel lines or other suitable means, enabling the easy uninstallation of the first and second structures 2,3 in the event of exchanges.

It should be noted that it is not necessary to provide any type of corner parts and/or reinforcements at the edges of the first and second structures 2,3, since, in cases of damage and/or breaks, the first and second structures 2,3 may be easily replaced due to their flexibility and ease of installation.

In addition, the installation of the weighing platform 100 on the third structure 4 guarantees the horizontality of its supports, with the leveling of the platform 100 being obtained according to the leveling of the ground, and obtaining said leveling is simple.

The foundation of the first and second structures 2, 3 in the ground takes place by filling concrete columns, a foundation that is usually used and known from the state of the art.

In addition, the bulkheads 101 are produced from metal material, being secured by staples, or in concrete, with holes being provided for fixing, or other suitable material for such application.

Also, the entire concrete frame has its iron ends facing the ground, preventing the animals from getting injured with the possible exposure of the metal frame due to the deterioration of the concrete.

In order to reinforce the non-exposure of the metal frame, one may appreciate that this frame is installed below the midline of the first and second structures 2,3.

Having described a preferred execution example, one must understand that the scope of this invention encompasses other possible variations, being limited solely by the content of the claims, including possible equivalences.

1. A weighing platform assembly base comprising: a first structure (2), a second structure (3) and a third structure (4), each of the first and second structures (2, 3) being associated to a longitudinal end of the third structure (4) to form the base (1), with the first, second and third structures (2, 3, 4) being pre-molded.

2. A weighing platform assembly base according to claim 1, characterized in that each of the first and second structures (2, 3) comprises:
a first end surface (5) and a second end surface (6), both of which are planar and rectangular in shape, the second end surface (6) being longitudinally opposite to the first end surface (5), the distance between the first and second end surfaces (5, 6) defining a first length (C1) of each of the first and second structures (2,3);
a first side surface (7) and a second side surface (8) projecting from the first end surface (5), both flat and rectangular in shape, arranged perpendicular to the first end surface (5), the first and second side surfaces (7, 8) being transversely opposite and spaced apart by a distance defining a first width (L1) of the first end surface (5);
the first and second side surfaces (7, 8) extending longitudinally towards the second end surface (6), to a first distance (D1) defining a width of the first and second side surfaces (7, 8);
a third side surface (9) and a fourth side surface (10) respectively projecting from the first and second side surfaces (7, 8), both flat and rectangular in shape, arranged perpendicular to the first and second surfaces (7, 8), the third and fourth side surfaces (9, 10) being longitudinally opposite to the first end surface (5);
the third and fourth side surfaces (9, 10) projecting from the first distance (D1) and extending transversely, in the direction opposite to a longitudinal axis of each of the first and second structures (2, 3), to a second distance (D2) defining the width of the third and fourth side surfaces (9, 10);
a fifth side surface (11) and a sixth side surface (12) projected, respectively, from the third and fourth side surfaces (9, 10), both flat and rectangular in shape, arranged perpendicular to the third and fourth side surfaces (9, 10), when a first angle (B) is equal to zero;
the fifth and sixth side surfaces (11, 12) being transversely opposite and spaced apart by a distance defining a second width (L2) of the second end surface (6);
the fifth and sixth side surfaces (11, 12) extending longitudinally from the first distance (D1) until they reach the second end surface (6);
a first face (13) and a second face (14) projecting from the first end surface (5) and extending longitudinally until they reach the second end surface (6), the first and second faces (13, 14) being flat and arranged perpendicularly to the first and second end surfaces (5, 6), when a second angle (D) is equal to zero;
the first face (13) being transversely opposite to the second face (14), being spaced apart by a distance defining a first height (H1) of the first and second structures (2,3).

3. A weighing platform assembly base according to claim 1, characterized in that each third structure (4) has a rectangular shape with a second length (C2), a third width (L3) and a second height (H2) and comprises:
a first groove (15) and a second groove (16), provided in a central portion of the longitudinal ends of the third structure (4), the first and second grooves (15, 16) being designed to engage the first and second structures (2, 3) with the third structure (4).

4. A weighing platform assembly base according to claim 3, characterized in that each third structure (4) further comprises a channel (17) extending transversely along an entire third width (L3) of the third structure (4) and defining a recess surface in a central portion of the third structure (4) with a third height (H3) smaller than the second height (H2).

5. A weighing platform assembly base according to claim 2, characterized in that the first angle (B) ranges from zero to 90 degrees, the fifth and sixth side surfaces (11, 12) being inclined in relation to the third and fourth side surfaces (9, 10) when the first angle (B) is greater than zero.

6. A weighing platform assembly base according to claim 2, characterized in that the second angle (D) ranges from zero to 90 degrees, the first face (13) being inclined in relation to the first and second end surfaces (5, 6) when the second angle (D) is greater than zero.

7. A weighing platform assembly base according to claim 1, characterized in that the weighing platform assembly base is further formed by a metal frame installed below a midline of the first and second structures (2,3), the metal frame comprises iron ends facing the ground.
